(19) United States
(12) Patent Application Publication
(10) Pub. No.: US 2021/0353978 A1
(43) Pub. Date: Nov. 18, 2021

(54) Unknown

(71) Applicant: Özgür GELES, Regensburg (DE)

(72) Inventor: Özgür GELES, Regensburg (DE)

(21) Appl. No.: 16/923,873

(22) Filed: Jul. 8, 2020

(30) Foreign Application Priority Data
May 18, 2020 (DE) 10 2020 113 405.3

(51) Int. Cl. A62B 18/08; A62B 18/02

(52) U.S. Cl. CPC A62B 18/086; A62B 18/084; A62B 18/025

(57) ABSTRACT

The present invention relates to a respiratory mask for filtering air consisting of a mask body, which is suitable for covering the nose and mouth of the mask wearer, comprising at least one holding means which is fastened to the respiratory mask and which is suitable for pulling the mask body against the face of the wearer. In this case, the mask body comprises at least one airlock device, through which connecting means, such as a straw, can be guided, so that the mask wearer can receive, for example inhale and/or drink, a use medium conveyed by the connecting means into an interior of the mask, i.e. the space between the face of the mask wearer and an inner surface of the mask, through his nose and/or mouth.

### TECHNICAL FIELD

The present invention relates to a respiratory mask for filtering air and, more particularly, a respiratory mask for filtering air that includes at least one holding means for pulling the mask body against the face of a wearer.

### SUMMARY

The present invention relates to a respiratory mask for filtering air consisting of a mask body, which is suitable for covering the nose and mouth of the mask wearer, wherein said mask at least one holding means which is fastened to the respiratory mask and which is suitable for pulling the mask body against the face of the wearer, wherein the mask body comprises at least one airlock device, through which connecting means, such as a straw, can be guided, so that the mask wearer can receive, for example inhale and/or drink, a use medium conveyed by the connecting means into an interior of the mask, i.e. the space between the face of the mask wearer and an inner surface of the mask, through his nose and/or mouth.

According to at least one embodiment, the respiratory mask comprises the airlock device which opens automatically, in particular also under pressure, as soon as the connecting means is at least partially guided through, and automatically closes again at least partially, preferably completely, as soon as the connecting means is guided out of the airlock device again.

According to at least one embodiment, the respiratory mask comprises an airlock device, which is formed by an opening in a wall of the mask body, into which an airlock element of the airlock device is inserted with a precise fit, and preferably in an airtight manner, wherein the airlock element comprises an airlock opening through which the connecting means can be guided into the interior.

According to at least one embodiment, the respiratory mask comprises an airlock element which has at least one closing element, through which the connecting means can be guided and which can be opened and closed again by mechanical force.

According to at least one embodiment, the respiratory mask comprises a closing element which, provided that the connecting means is guided through it, is at least partially airtight, preferably completely airtight.

According to at least one embodiment, a closing element is attached, which is formed with a plastics material, for example a silicone, which can be pierced by the connecting means using mechanical force.

According to at least one embodiment, the closing element which is designed in the form of a flat, but at least partially flexible, stretchable and/or bendable form and which is inserted in an air-flush manner into the opening of the wall of the mask body and forms at least one connecting slot or forms such a slot in the closing element comprises, so that the connecting means can be guided through this slot, preferably non-destructively, into the interior of the mask.

The method for producing a respiratory mask therefore comprises providing at least one mask body which is suitable for covering the nose and mouth of the mask wearer, introducing at least one through-opening in the mask body and introducing at least one airlock device which is configured and provided for allowing connecting means, such as a straw, to be guided through it, so that the mask wearer can receive, for example inhale and/or drink, a use medium conveyed by the connecting means into an interior of the mask, i.e. the space between the face of the mask wearer and an inner surface of the mask, through his nose and/or mouth.

The present invention is explained in more detail below on the basis of an embodiment and a drawing.

### BRIEF DESCRIPTION OF THE DRAWING

FIG. 1 is a front view of an exemplary respiratory mask in accordance with various aspects of the disclosure.

### DETAILED DESCRIPTION OF EMBODIMENTS

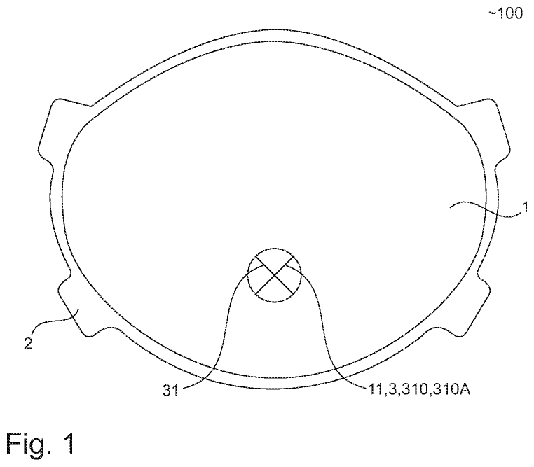

FIG. 1 shows in this case a mask body 1 of a respiratory mask 100, which is suitable for covering the nose and mouth of the mask wearer, and at least one holding element 2 fastened to the respiratory mask 100, which is suitable for pulling against the face of the wearer, wherein the mask body 1 comprises at least one airlock device 3, through which connecting means, such as a straw, can be guided, whereby the mask wearer can receive, for example inhale and/or drink, a use medium conveyed by the connecting means into an interior of the mask, i.e. the space between the face of the mask wearer and an inner surface of the mask, through his nose and/or mouth.

The airlock device 3 is formed by an opening in a wall of the mask body, into which an airlock element 31 of the airlock device 3 is guided with a precise fit, and preferably in an airtight manner, wherein the airlock element 3 comprises an airlock opening 3 through which the connecting means can be guided into the interior, and wherein the airlock device 3 opens automatically, in particular also under pressure, as soon as the connecting means is at least partially guided through, and automatically closes again at least partially, preferably completely, as soon as the connecting means is guided out of the airlock device 3 again.

In addition, it is shown that the airlock element 31 has at least one closing element 310, through which the connecting means can be guided and which can be opened and closed again by mechanical force and which is at least partially airtight, preferably completely airtight, provided that no connecting means is guided through it.

The closing element 310 is an element formed with plastics material, for example a silicone, which can be pierced by the connecting means using mechanical force, and wherein the closing element 310 is designed in the form of a flat, but at least partially flexible, stretchable and/or bendable form which is inserted in an air-flush manner into the opening of the wall of the mask body 1.

In particular, the closing element 310 forms at least one connecting slot 310A, so that the connecting means can be guided through this slot 310A, preferably non-destructively, into the interior of the mask.

### LIST OF REFERENCE NUMERALS

1 Mask body

2 Holding means

3 Airlock device

11 Opening

31 Airlock element

100 Respiratory mask

310 Closing element

310A (Connecting) slot

1. Respiratory mask (100) for filtering air consisting of:
a mask body (1), which is suitable for covering the nose and mouth of the mask wearer,
at least one holding means (2) which is fastened to the respiratory mask and which is suitable for pulling the mask body (1) against the face of the wearer,
wherein
the mask body (1) comprises at least one airlock device (3), through which connecting means, such as a straw, can be guided, so that the mask wearer can receive, for example inhale and/or drink, a use medium conveyed by the connecting means into an interior of the mask, i.e. the space between the face of the mask wearer and an inner surface of the mask, through his nose and/or mouth.

2. Respiratory mask (100) according to claim 1,
wherein
the airlock device (3) opens automatically, in particular also under pressure, as soon as the connecting means is at least partially guided through, and automatically closes again at least partially, preferably completely, as soon as the connecting means is guided out of the airlock device (3) again.

3. Respiratory mask (100) according to claim 1,
wherein
the airlock device (3) is formed by an opening in a wall of the mask body (1), into which an airlock element (31) of the airlock device (3) is inserted with a precise fit, and preferably in an airtight manner, wherein the airlock element (3) comprises an airlock opening (3) through which the connecting means can be guided into the interior.

4. Respiratory mask (100) according to claim 1,
wherein
the airlock element (31) has at least one closing element (310), through which the connecting means can be guided and which can be opened and closed again by mechanical force.

5. Respiratory mask (100) according to claim 1,
wherein
the closing element (310), provided that no connecting means is guided through it, is at least partially airtight, preferably completely airtight.

6. Respiratory mask (100) according to claim 1,
wherein
the closing element (310) is formed with a plastics material, for example a silicone, which can be pierced by the connecting means using mechanical force.

7. Respiratory mask (100) according to claim 1,
wherein
the closing element (310) forms at least one connecting slot (310A) or such a slot is formed in the closing element (310) so that the connecting means can be guided through this slot (310A), preferably non-destructively, into the interior of the mask.

8. Respiratory mask according to claim 1,
wherein
the closing element (310) is designed in the form of a flat, but at least partially flexible, stretchable and/or bendable form which is inserted in an air-flush manner into the opening of the wall of the mask body (1).

9. Method for producing a respiratory mask, in particular according to claim 1, comprising the following steps:
providing at least one mask body (1) which is suitable for covering the nose and mouth of the mask wearer,
introducing at least one through-opening (11) into the mask body,
introducing at least one airlock device (3), which is configured and provided for allowing connecting means, such as a straw, to be guided through it, so that the mask wearer can receive, for example inhale and/or drink, a use medium conveyed by the connecting means into an interior of the mask, i.e. the space between the face of the mask wearer and an inner surface of the mask, through his nose and/or mouth.
